(19) United States
(12) Patent Application Publication
(10) Pub. No.: US 2020/0324247 A1
(43) Pub. Date: Oct. 15, 2020

(54) SYSTEM FOR CLOSED CIRCUIT DESALINATION WITH RENEWABLY SOLAR/WIND ENERGY SOURCES OF VARIABLE POWER CHARACTERISTICS

(71) Applicant: DESALITECH LTD., Kfar Saba (IL)

(72) Inventor: Avi EFRATY, Har Adar (IL)

(21) Appl. No.: 16/647,966

(22) PCT Filed: Sep. 13, 2018
(86) PCT No.: PCT/IL2018/051032

§ 371 Date: Mar. 17, 2020

(30) Foreign Application Priority Data
Sep. 25, 2017 (IL) 254725

(51) Int. Cl. B01D 61/08; C02F 1/44; B01D 61/02; B01D 61/12

(52) U.S. Cl. CPC B01D 61/08; C02F 1/441; C02F 2103/08; B01D 61/12; B01D 61/025

(57) ABSTRACT

A system of closed circuit desalination (CCD) units powered by solar panels and/or wind turbines through a buffer battery and a DC/AC converter, operating by a change of flux as function of the power availability from the abovementioned natural energy sources, while the load of the buffer battery remains at a preselected level is provided. The programmable logic controller of the system continuously tracks the battery load; in case of drop in load (output>input) the system responds periodically by a flux decline or by a flux increase in case of load increase (output<input), such that the average battery load remains around the preselected level. Permeate production by the system proceeds as function of the NMEn configuration of the CCD unit (N, module-number; n element-number), the area of solar panels and/or the rotor sweep area of the wind turbines, and the power availability of the renewable energy source.

### BACKGROUND OF THE INVENTION

Increased demand for clean power generation from free renewable energy sources in order to ease the “global greenhouse effect”, led to the development and commercialization of cost effective solar panels and small wind turbines, which could supply free power off grid in needy places on Earth. The application of renewable energy sources for desalination and water treatment should enable low cost potable water supplies to a large fraction of the growing global population (˜7.2 billions) in islands, coastal regions and inland locations of scarce water supplies where local grid doesn't exist or provides expensive electricity. If 25-50-100 liter/day/person potable water consumption are considered low-medium-high standard, respectively, small desalination units of 5, 10, 25, 50, and 100 m³/day capacity operated with free solar/wind power should enable supply of quality water free of contamination to communities of 200-100-50; 400-200-100; 1,000-500-259 and 2,000-1,00-500 residents, respectively. Water consumption takes place mostly during day time and therefore, desalination units operated only by solar power should meet all daily water needs during the 6-8 hours of effective day light; whereas, desalination units operated by wind power are unrestricted to day light and the night production stored for use during the day.

### SUMMARY OF THE INVENTION

The solar power (P_{S}) availability on Earth surface can be expressed by (1) as defined from the solar constant in space (1.353 kW/m²) and accounting for the fraction of solar radiation lost in the atmosphere (δ) which is approximately 50% in clear sky and more in cases of clouds and/or fog. If the efficiency of DC current production by solar panels is expressed by φ and that of DC→AC power conversion factor expressed by Ω, the AC power made available from solar radiation on Earth can be expressed by (2). Solar radiation on a flat surface area on Earth varies during the day and defined by cos(α); where, α is the angle between the incident radiation and the normal to the flat surface area, and this implies maximum power deposition in midday, low power depositions in the morning and late afternoon, and a confined number daily hours of effective power deposition. Annual solar energy deposition per surface area (kWh/m2/year) in several global regions and their translation to DC energy assuming φ=0.22 (in parenthesis) revealed: 1,000 (200) in central Europe, Asia and Canada; 1,500 (330) in central USA; 1,750 (385) around the Mediterranean; and 2,200 (484) in Equatorial Africa as well as in the desert regions in the Middle east, Australia, Africa and America. The cited figures already take account of large summer/winter seasonal variations with estimated 25% lower values from the average in mid-winter and 25% higher values in mid-summer. Accordingly, a desert region of 484 kWh/m²/year average annual DC energy deposition should experience seasonal variations in the range of 363-605 kWh/m²/year which translate to a daily average range of 0.99→1.66 kWh/m²/day. Assuming an average of 6-8 hours of daily effective solar radiation in desert regions during the winter and summer seasons, respectively, the above cited figures translate to an average of 165→207 Wh/m² or 13.7→17.2 Ampere-hour/m² current input to a 12 Volt battery per square meter of a solar panel and this figures per 30 m² solar panels translate to 29.7→49.8 kWh/day during the winter and summer seasons, respectively.

P_{S}(kW/m²)=1.353*(1−δ) (1)

P_{S}(kW/m²)=1.353*(1−δ)*φ*Ω (2)

Wind turbine power (Pw) is expressed by (3); wherein, η stands for a power coefficient of 16/27(59.26%) theoretical maximum, d for air density, R for rotor's radius and v for wind velocity. The wind power equation takes the form of (4) in kW when d=1.2* 10⁻³ kg/m³, R expressed in meter and v in m/s. It should be pointed out that the power coefficient depends on the tip-speed-ratio (λ) expressed by (4); wherein, u stands for the tip-speed velocity of the rotor and φ for its rotational speed (RPM). Windmill rotors are made by design to operate in the high power coefficient range (0.35-0.45) at the nominal wind velocity frequency which is of band of the highest energy content.

P_{W}=(½)*η*d*(π*R²)*v³ (3)

P_{W}(kW)=1.884*10⁻³*η*R²*v³ (4)

λ=u/v=(2*π*Rφ)/v (4)

Wind regimes can be rated according to their average annual natural wind energy availability per unit area perpendicular to the sweep of the rotor (kWh/m²/year) such as excellent for 3,250±250 (8.90±0.68); very-good for 2,750±250 (7.53±0.68); good for 2,250±250 (6.16±0.68); medium for 1,750±250 (4.79±0.68); and poor under 1,250 (3.42); wherein, the data in parenthesis is that of a daily average (kWh/m²/day). Wind power can be experienced over 24 hours a day with an average power output for the respective cited regimes expressed by 370±28; 313±28; 257±28; 199±28; and 142±28 Wh/m² which translate to 30.7; 26.1; 21.4; 16.5; and 11.8 ampere-hour/m² current input to a 12 Volt battery per square rotor sweep. Since wind velocity variations are common and depend on frequencies, effective wind turbines should be able to operate efficiently also above the nominal wind velocity, the frequency of the highest energy content.

The data furnished hereinabove enables a to estimate the continuous accumulation of solar and/or wind energy in a fixed voltage battery according to solar radiation regions and wind regimes, as exemplified next for a typical desert region of a medium wind regime characteristics where maximum solar radiation will charge a 12 volt battery at an average annual rate of 15.4 (13.7→17.2) ampere-hour/m² comparable to a medium wind regime (16.5) and not far removed from that of a poor wind regime (11.8) with area in the former related solar panels and in the latter to a rotor's sweep—under said conditions the solar and wind variable power sources are expected to provide a total average of 39.9 (15.4±16.5) ampere-hour/m² or 0.958 kWh/m²/day per one square-meter collection area (CA) each, or 9.50 kWh/day per 10 m² CA; 19.20 per 20 m² CA; 28.7 per 30 m² CA; 38.2 per 40 m²; 49.9 per 50 m² CA.

The application of solar/wind power for desalination by ordinary direct pass RO techniques of fixed pressurized flow at inlet require batteries of large enough energy storage capacity to enable durable a performance. Alternatively, the application of such energy sources for continuous desalination with a small battery capacity can be made possible if permeates' production proceeds under variable flux as function of power availability. The present invention describes systems for closed circuit desalination under variable flux conditions with renewably solar/wind energy sources of variable power characteristics, intended for water supplies to small communities where a local grid doesn't exist or provide expensive electricity.

The inventive system for water desalination with renewable energy sources describes the integration of a batch close circuit desalination (CCD) unit of NMEn configuration (N modules each of n elements) with solar panels and/or wind turbines of variable power output, through a small capacity buffer battery also equipped with a battery load monitor (BLM) and a DC/AC power conversion means.

The inventive system is made to operate continuously, pending a sufficient power availability from the cited natural energy source, by a programmable logic controller (plc) board in said CCD unit based on operational set-points (flux, module recovery and sequence recovery) which enables a periodic flux correction in response to online BLM signals from the storage battery, such that a declined BLM signal due to output>input is periodically responded through the plc board with a flux decline to affect output≤input in the buffer battery; an increased BLM signal due to output<input responded by a flux increase to affect output≤input, and an unchanged BLM signal not affecting flux. A periodic flux correction through the plc is aimed to enable the buffer battery sustain a certain predefine BLM level (e.g., 50%), accordingly, deviation from said level due to change in power availability is responded through the plc by flux adjustments. The plc board is expected to stop the desalination unit at its lowest designated operational flux below a certain predefined minimum (e.g., 10% BLM) for lack of sufficient power availability, or disconnect the energy collecting lines to the battery at a certain predefined maximum BLM value (e.g, 90%) under maximum predefined operational flux conditions in order to avoid damage to the battery due to overcharge.

In contrast with traditional direct-pass RO techniques, CCD is the only method which enables large flux variations without exceeding manufacturers' specifications of elements and this irrespective of the number of element per module and/or the module recovery and/or the batch sequence recovery. The inventive system operations are illustrated with single-element CCD units for seawater desalination of 43.4% recovery in the flux rang 8-28 in Example 1 and for brackish water desalination of 85% recovery in the flux range 10-37 in Example 2.

According to some embodiments, a system for RO desalination driven by a clean energy harvesting device from a variable power renewable natural energy source through an energy storage means, includes:

RO desalination proceeding in a batch closed circuit desalination (CCD) unit comprising one or more than one module in parallel, each of one or several membrane elements; a closed circuit concentrate recycling line with a circulation means from outlet(s) to inlet(s) of said module(s); a feed line with pressurizing means to inlet(s) of said module(s); a permeate release line off said module(s); and a line off said concentrate recycling line with actuated valve (AV) and check valve (CV) means to enable a brief periodic brine replacement by feed at low pressure after each batch desalination sequence under fixed flow and variable pressure conditions controlled by operational set-points of flux, module recovery and sequence recovery;

an energy harvesting device for conversion of variable power natural energy to DC (ampere-hour) as function power availability;

an energy storage means referring to a fixed voltage battery of a defined maximum (ampere-hour) capacity wherein said DC (ampere-hour) energy is collected as function power availability of said natural energy source and wherefrom energy is transmitted to said CCD unit through a DC/AC converter as function of its operation flux set-point, with said battery also equipped with a battery load monitor (BLM) which also shows of its remaining energy capacity as results of the input-output balance change;

whereby said system is made to operate continuously, pending a sufficient power availability from said natural energy source, by a programmable logic controller (plc) in said CCD unit with operational set-points of flux, module recovery and sequence recovery which also receives online data from said BLM and affects a periodic change of flux with a declined BLM capacity signal due to output>input responded by a declined flux is said CCD unit to enable output<input into said battery and with an increased BLM capacity signal due to output<input responded by an increased flux is said CCD unit to enable output>input into said battery and the intent of said periodic change of flux procedure is to restore BLM capacity at a desired predefined level (e.g., 50%) while said CCD unit operate, as well as to temporarily disconnect the line from said energy harvesting device to said batter when said CCD unit operates in its maximum defined flux range while the BLM capacity exceeds a maximum defined level (e.g., ≤90%) to avoid overcharge damage to said battery, or stop said CCD unit for lack of sufficient power when said CCD unit operates in its minimum defined flux range while the BLM capacity drops below a defined minimum value (e.g., 10%).

According to some embodiments, the pressurizing means (HP-vfd) is a high pressure pump with variable frequency drive means to enable controlled flow rates.

According to some embodiments, the circulation means (CP-vfd) is a flow circulation pump of a low pressure difference with variable frequency drive means to enable controlled flow rates.

According to some embodiments, the actuated valve means (AV) is a two-way valve of an closed/opened positions controlled by said plc with a closed position experienced during said batch desalination sequences and an opened position during said brief periodic brine replacement by feed at low pressure after each batch desalination sequence; and said check valve (CV) means dictate the flow direction in said concentrate recycling line during said brief periodic brine replacement by feed.

According to some embodiments, the energy harvesting device refers to solar panels for solar radiation conversion to DC (ampere-hour) energy as function solar energy availability.

According to some embodiments, the energy harvesting device refers to a wind turbine with a DC generator for wind power conversion to DC (ampere-hour) energy as function of wind power availability.

According to some embodiments, the energy harvesting device refers to solar panels and wind turbines with DC generators together for continuous generation of DC (ampere-hour) energy as from both said sources simultaneously.

According to some embodiments, the feed water to said system may comprise seawater, or brackish water, or contaminated ground and/or surface water depending on the specific design of said system.

### BRIEF DESCRIPTION OF THE DRAWINGS

FIG. 1, showing a schematic design of the inventive system for CCD desalination with power solely derived from solar panels.

FIG. 2, showing a schematic design of the inventive system for CCD desalination with power solely derived a wind turbine.

FIG. 3, showing a schematic design of the inventive system for CCD desalination with power derived simultaneously from solar panels and a wind turbine.

FIG. 4A, showing a schematic design of a single-element CCD unit for seawater desalination during its CCD desalination mode in the context of the inventive system.

FIG. 4B, showing a schematic design of a single-element CCD unit for seawater desalination during its brine replacement mode by feed in the context of the inventive system.

FIG. 5A, showing the relationship of specific energy vs flux in Example 1 for seawater desalination of a single-element CCD unit with solar and/or wind renewable energy sources.

FIG. 5B, showing the relationship of permeates' salinity vs flux in Example 1 for seawater desalination of a single-element CCD unit with solar and/or wind renewable energy sources.

FIG. 5C, showing the relationship of hourly production of permeates vs flux in Example 1 for seawater desalination of a single-element CCD unit with solar and/or wind renewable energy sources.

FIG. 5D, showing the relationship of daily production of permeates vs flux in Example 1 for seawater desalination of a single element CCD unit with solar and/or wind renewable energy sources.

FIG. 5E, showing the relationship of CCD sequence time vs flux in Example 1 for seawater desalination of a single-element CCD unit with solar and/or wind renewable energy sources.

FIG. 5F, showing the relationship of % battery loading monitor vs flux in Example 1 for seawater desalination of a single-element CCD unit with solar and/or wind renewable energy sources.

FIG. 6A, showing a schematic design of a single-element CCD unit for brackish water desalination during its CCD desalination mode in the context of the inventive system.

FIG. 6B, showing a schematic design of a single-element CCD unit for brackish water desalination during its brine replacement mode by feed in the context of the inventive system.

FIG. 7A, showing the relationship of specific energy vs flux in Example 2 for brackish water desalination of a single-element CCD unit with solar and/or wind renewable energy sources.

FIG. 7B, showing the relationship of permeates' salinity vs flux in Example 2 for brackish water desalination of a single-element CCD unit with solar and/or wind renewable energy sources.

FIG. 7C, showing the relationship of hourly production of permeates vs flux in Example 2 for brackish water desalination of a single-element CCD unit with solar and/or wind renewable energy sources.

FIG. 7D, showing the relationship of daily production of permeates vs flux in Example 2 for brackish water desalination of a single-element CCD unit with solar and/or wind renewable energy sources.

FIG. 7E, showing the relationship of CCD sequence time vs flux in Example 2 for brackish water desalination of a single-element CCD unit with solar and/or wind renewable energy sources.

FIG. 7F, showing the relationship of % battery loading monitor vs flux in Example 2 for brackish water desalination of a single-element CCD unit with solar and/or wind renewable energy sources.

### DETAILED DESCRIPTION OF THE INVENTION

The inventive system of the preferred embodiment described hereinafter comprises a batch closed circuit (CCD) unit with power link to natural clean energy sources of variable power characteristics, such as solar panels and/or wind turbines, through a buffer battery of fixed voltage, for continuous production of permeates with a flux rate proportional to the power availability from the natural sources.

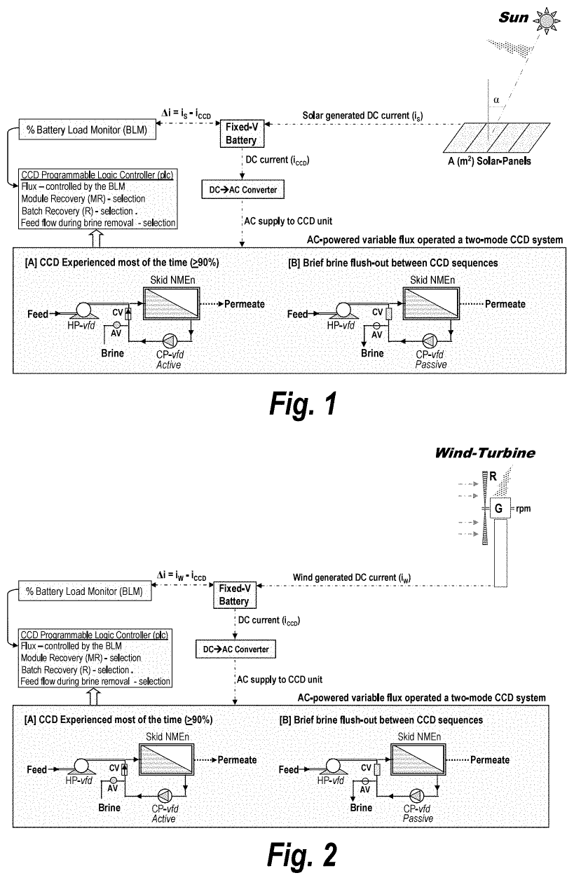

The inventive system of the preferred embodiment for continuous CCD with natural clean energy sources of variable power characteristics; wherein, solar panels (SP) used as the sole energy source is described schematically in FIG. 1, showing SP of a defined surface area (A, m²) with a DC line link to a fixed-voltage battery equipped with a % Battery Load Monitor (BLM); wherein, energy is collected at variable ampere-hour (i_{S}) from the SP and supplied to the CCD unit according to its energy demand (i_{CCD}) through a DC/AC converter. The % BLM provides a measure of the energy production-consumption difference (Δi=i_{S}−i_{CCD}) and implies an unchanged load when i_{S}=i_{CCD}, an increased load when i_{S}>i_{CCD} and a declined load when i_{S}<i_{CCD}.

The batch CCD unit in the design (FIG. 1) comprises a skid of N modules with their inlets and outlets connected in parallel, each of n element; a closed circuit line with a circulation means (CP, circulation pump) for concentrate recycling, a high pressure pump (HP) means for pressurized feed supply to inlet of said skid; check valve means (CV) for flow direction control, a line extension off said concentrate recycling line with an actuated valve means (AV) to enable periodic brine replacement by feed; and a plc board of four principle set-points (flux, module recovery, batch sequence recovery, and feed flow during brine removal) whereby said CCD unit can execute continuously and autonomously a two-mode consecutive sequences of CCD under fixed flow and variable pressure conditions most of the time (>90%) with brief steps of brine replacement by freed between said CCD sequences (FIG. 1[A]-[B]). The operational set-points are selected independent of each other and may be changed, including online. The fixed flow conditions, including flux, during CCD are maintained by the variable frequency drive (vfd) means of pumps (HP-vfd and CP-vfd) controlled by online flow/volume monitoring means. The selected CCD operational set-point of recovery (MR) expressed by MR=Q_{HP}/(Q_{HP}+Q_{CP})=Q_{P}+Q_{CP}) is maintained by the flow control of permeate (Q_{P}=Q_{HP}) and cross-flow (Q_{CP}) and the attainment of the selected batch sequence recovery (R) is determined by the monitored permeate volume (ΣV_{P}) or pressurized feed volume (ΣV_{HP}) according to the expression R=ΣV_{HP}/(ΣV_{HP}+Vᵢ)=ΣV_{P}/(ΣV_{P}=Vᵢ); wherein, Vᵢ stands for the fixed intrinsic volume the closed circuit in said CCD apparatus whose brine content (Vᵢ) after each CCD sequence needs to be replaced by feed at low pressure with an accelerated flow rate set-point of HP.

In the integration of the CCD unit with the variable power clean energy source proceeds by a plc link between the flux (μ) and % PLM (φ) with a declined φ affecting a declinedμ and vice versa. The battery should provide a sufficient buffer for periodic adjustments of flux to enable a continuous desalination process. The inventive system is made to operate continuously, pending a sufficient power availability from the cited natural energy source, by a programmable logic controller (plc) of said CCD unit operational set-points (flux, module recovery and sequence recovery) with a periodic flux correction in response to online data of said BLM signals, such that a declined BLM signal due to output>input is periodically responded through the plc board with a flux decline to affect output≤input in the buffer battery; an increased BLM signal due to output<input responded by a flux increase to affect output≤input, and an unchanged BLM signal leaves the flux unchanged. A periodic flux correction through the plc is aimed to enable the buffer battery sustain a certain predefine BLM level (e.g., 50%), accordingly, deviation from said level due to change in power availability is responded through the plc by flux adjustments. The plc board is designed to stop the desalination unit at its lowest designated operational flux below a certain predefined minimum (e.g., 10% BLM) for lack of sufficient power availability, or disconnect the energy delivery lines to the battery at a certain predefined maximum BLM value (e.g, 90%) under maximum predefined operational flux conditions in order to avoid damage to the battery due to overcharge.

The solar energy range made available to the CCD unit will depends on the surface area of (A, m²) the solar panels and both the consumed energy (ΣkWh) and generate volume (Σm³) of permeates per sequence define the specific energy (SE) expressed by SE=(ΣkWh)/(Σm³), which is expected to be low since CCD proceeds with a near absolute energy conversion efficiency without need for energy recovery in the absence of pressurized brine flow release during the process. The battery in this process serves only as a buffer of energy input and output and its energy storage capacity should account for the periodic BLM changes between flux adjustments.

The inventive system of the preferred embodiment for continuous CCD with natural clean energy sources of variable power characteristics; wherein, wind power from a wind-turbine (WT) used as the sole energy source is described schematically in FIG. 2, showing a WT of a defined rotor radius (R) and sweep (π*R²) perpendicular to the wind's direction, with a DC line link from the wind driven DC generator (G) to a fixed-voltage battery equipped with a % Battery Load Monitor (BLM); wherein, energy is collected at variable ampere-hour (i_{W}) from the WT and supplied to the CCD unit according to its energy demand (i_{CCD}) through a DC/AC converter. The WT is also equipped with a rotor shaft revolution (rpm) meter and a breaks mechanism (not shown) to enable the stopping of the rotor motion beyond a defined speed (rpm) in order to avoid damage by occasional high winds. The % BLM provides a measure of the energy production-consumption difference (Δi=i_{W}−i_{CCD}) and implies an unchanged load when i_{W}=i_{CCD}, an increased load when i_{W}>i_{CCD} and declined load when i_{W}<i_{CCD}. The variable flux control of the CCD unit as function of power availability through the buffer battery is managed by the plc board on the basis of the same principles already described hereinabove in the context of solar panels.

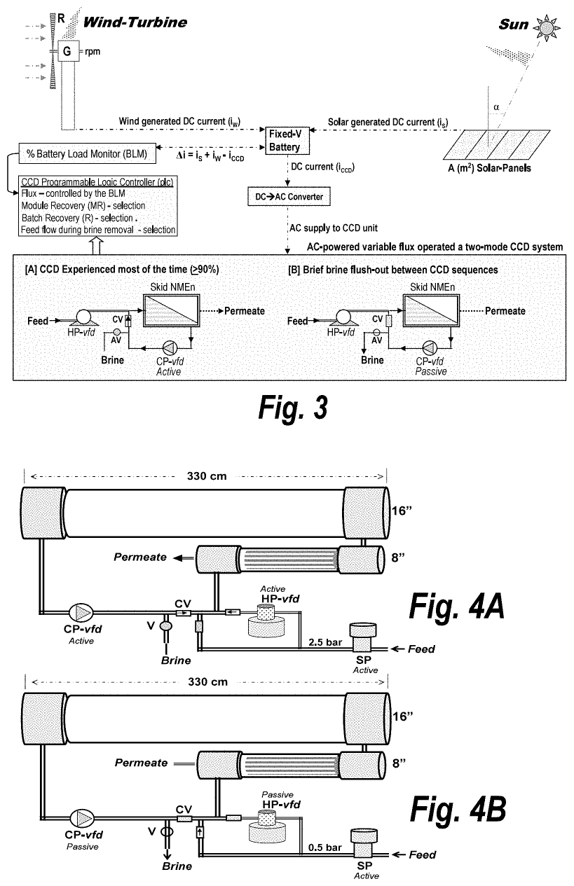

The inventive system of the preferred embodiment for continuous CCD with natural clean energy sources of variable power characteristics; wherein, such sources comprise of both solar panels (SP) and wind-turbines (WT) is described schematically in FIG. 3, showing that both sources provide DC energy to the same fixed-voltage battery equipped with a % BLM; wherein, energy is collected at variable ampere-hour from the SP(i_{S}) and WT(i_{W}) and supplied to the CCD unit according to its energy demand (i_{CCD}) through a DC/AC converter. The % BLM provides a measure of the energy production-consumption difference (Δi=i_{S}+i_{W}−i_{CCD}) and implies an unchanged load when i_{S}+i_{W}=i_{CCD}, an increased load when i_{S}+i_{W}>i_{CCD}, and a declined load when i_{S}+i_{W}<i_{CCD}. The variable flux control of the CCD unit as function of power availability through the buffer battery is managed by the plc board on the basis of the same principles already described hereinabove in the context of solar panels.

If the components in the CCD unit are powered by DC instead of AC, the need for a DC→DC converter displayed in FIG. 1, FIG. 2 and FIG. 3 is circumvented.

Although the inventive system of the preferred embodiment is exemplified below with single-element CCD units for seawater (35,000 ppm) desalination (43.9% recovery and average 16.1 m³/day permeates production) in Example 1 and for brackish water (1,000 ppm) desalination (85% recovery and average of 23.5 m³/day) in Example 2, it should be obvious to the skilled in the art that the inventive system is not confined to a single-element configuration and may comprise larger CCD units of many modules connected in parallel, each one or more than one element, for a much greater production of permeates when linked to solar panels and/or wind turbine(s) of a sufficient energy collection area in compliance with the permeates production requirements. The choice of single-element CCD unit illustrations of the inventive system for desalination with renewable clean energy sources was not a coincident, since intended to show the minimum permeates production capacity made possible by this approach and the incentives created for small communities for its adaptation.

It will be also understood to the skilled in the art that the inventive system of the preferred embodiment and its principle actuation modes described hereinabove on the basis of FIG. 1, FIG. 2 and FIG. 3 are schematic and simplified and are not to be regarded as limiting the invention, but as an example of the many diverse implementation of the invention. In practice, the inventive system may comprise many additional lines, branches, valves, and other installations and devices as deemed necessary according to specific requirements while still remaining within the scope of the invention's claims. The basic design concepts and control principles of the inventive system are not limited by the area of solar panels and/or by the rotor size of the wind-turbine and/or by the battery energy capacity which may be expanded to an assembly of batteries connected in parallel and/or by the design of the CCD unit which may comprise one or more than one module, each of one or more than one element, as long as the selection of parts and components enable effective desalination under variable flux conditions in accordance with the power availability of the variable power clean energy sources, one or more, whereby the inventive system is made to operate.

While the invention has been described hereinabove in respect to particular embodiments, it will be obvious to those versed in the art that changes and modifications may be made without departing from this invention in its broader aspects, therefore, the appended claims are to encompass within their scope and all the changes and modifications as fall within the true spirit of the invention.

### EXAMPLE 1

The inventive system for CCD desalination comprising a batch CCD-SWRO unit of the design in FIG. 4(AB) [A, desalination sequence mode and B, brine replacement mode] with a single-element (SWC6-LD) module; driven by 18.5 m² solar panels, or by two wind-turbines (each, 1.85 m rotor radius driven generator of 1.25 kW), or both, through a buffer battery (12 volt and 1,000 ampere-hr); in a desert region Ocean (3.5%) coastline location of an average 2,200 kWh/m²/year surface energy of solar origin and a medium wind regime location of an average 2,200 kWh/m²/year with 8.0 m/s (28.8 km/hr) nominal wind velocity; is exemplified by simulation for permeate production of 43.9% recovery with fixed module recovery of 8% (1.14 av-pf) under variable flux conditions (8→28 lmh) as function of the power availability of the cited natural energy sources. The consecutive sequential batch CCD simulations assumes the efficiency of 85% for HP-vfd and 75% for both CP-vfd and the feed supply service pump (SP); 2.5 minute intervals of brine replacement by feed at low pressure (0.5 bar) between CCD sequences; and a periodic (e.g., every 30 min.) flux correction as function of % BLM through the plc board such that the percent change of the battery load expressed by [BLM_{monitored}BLM_{50%}/BLM_{50%}] translates to a relative change of flux from its midrange (18 lmh) or from a different desired reference level. A declined BLM signal manifests a lower input than output to the buffer battery and this is corrected by a declined operational flux and vice-versa.

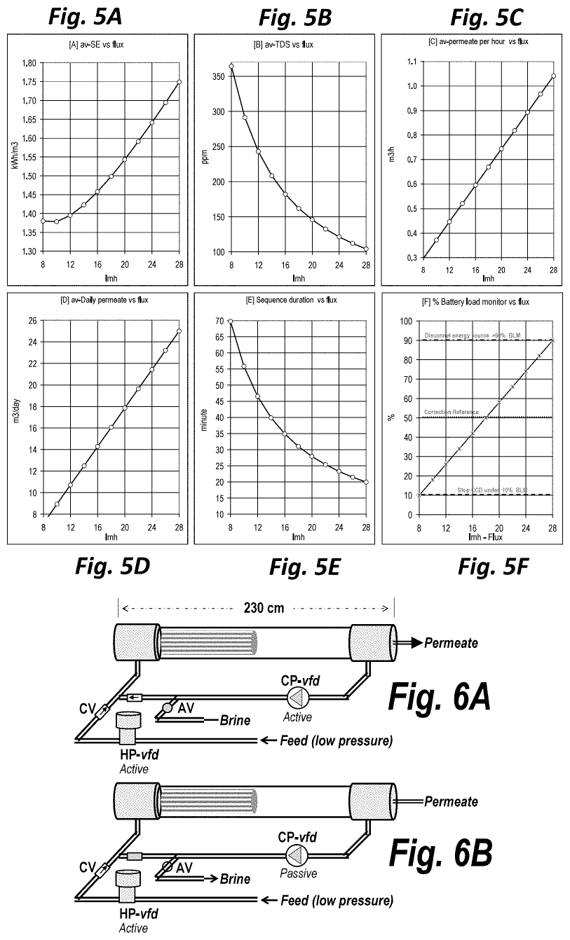

The performance simulation results as function of flux in the exemplified inventive system in FIG. 5(AF) show in [A], the average specific energy (av-SE); in [B], the average salinity (ppm, TDS) of permeates; in [C], the average hourly permeates production; in [D], the average daily permeates production; in [E], the average batch sequenced time duration; and in [F], the correlation between flux and % BLM signals with a correction reference of 50% BLM, stop CCD operation reference under 8 lmh and a 10% BLM signal, and the disconnection reference of the battery from the natural energy source above 28 lmh and a 90% BLM signal to prevent damage due to overcharge.

The illustrated inventive system described hereinabove for Ocean water (3.5%) may apply to seawater of different salinity such as Mediterranean water (4.0%) in which case the same average permeates production of 16.1 m³/day will require and increased areas of solar panels and rotor sweep area of a wind turbine of ˜15% in order to accommodate for the extra power needs.

Under the annual solar and wind conditions in the location of the exemplified inventive system, the average annual projected daily permeates production is 16.1 m³/day (grater average during the summer and less during the winter seasons) when operated only by solar panels according to the FIG. 1A design; or only by the wind turbines according to the FIG. 1B design; or by solar panels of half the area and one wind turbine according to the FIG. 1C design. Stated production of seawater (3.5%) desalination permeates should meet the demand of a community of 161 residents at the consumption level of 100 liter/day/person and twice the resident number (322) at 50 liter/day/person average consumption. Components of the single element CCD unit, solar panels, small wind turbine (R=1.85 m; 1.25 kW DC generator and 8-10 m long steel pipe support structure) and battery are common, readily available and inexpensive, suggesting both the cost-effectiveness and affordability of the exemplified inventive system, and alike of a greater production capacity, for extensive worldwide application in needy locations.

### EXAMPLE 2

The application of the inventive system exemplified hereafter demonstrates the use of solar and/or wind clean energy for potable water supplies from contaminated and/or salty surface and/or ground water sources with a single element batch CCD unit of fixed flow and variable pressure operation with long CCD sequence experienced most of the time and brief stops for brine replacement by feed executed between said sequences.

The inventive system for CCD desalination comprising a batch CCD-BWRO unit of the design in FIG. 6(AB) [A, desalination sequence mode and B, brine replacement mode] with a single element (ESPA2-MAX) module; driven by 8 m² solar panels, or by one wind-turbine (R=1.6 m rotor radius and a 0.55 kW DC generator), or both, through a buffer battery (12 volt and 750 ampere-hr); in a region of 2,200 kWh/m²/year average surface energy of solar origin of a medium wind regime (average 2,200 kWh/m²/year) of 8.0 m/s (28.8 km/hr) nominal wind velocity. The illustrated system desalinates a feed source of salinity equivalent to 1,000 ppm NaCl with 10% module recovery (1.17 av-pf), 85% CCD sequence recovery and flux correction as function of power availability.

The inventive system is intended for permeate production of 85% recovery with a fixed module recovery of 10% (1.17 av-pf) under variable flux conditions (10→37 lmh) as function of the power availability of the cited natural energy sources. The consecutive sequential batch CCD simulations assumes pumps efficiency of 70% for both HP-vfd and CP-vfd; 2.0 minute intervals of brine replacement by feed at low pressure (0.5 bar) between CCD sequences; and a periodic (e.g., every 30 min.) flux correction as function of % BLM through the plc board, such that the percent change of the battery load expressed by [BLM_{monitored}−BLM_{50%}/BLM_{50%}] translates to a relative change of flux from its midrange (23.5 lmh) or from a different desired reference level. A declined BLM signal manifests a lower input than output to the buffer battery and this is corrected by a declined operational flux and vice-versa.

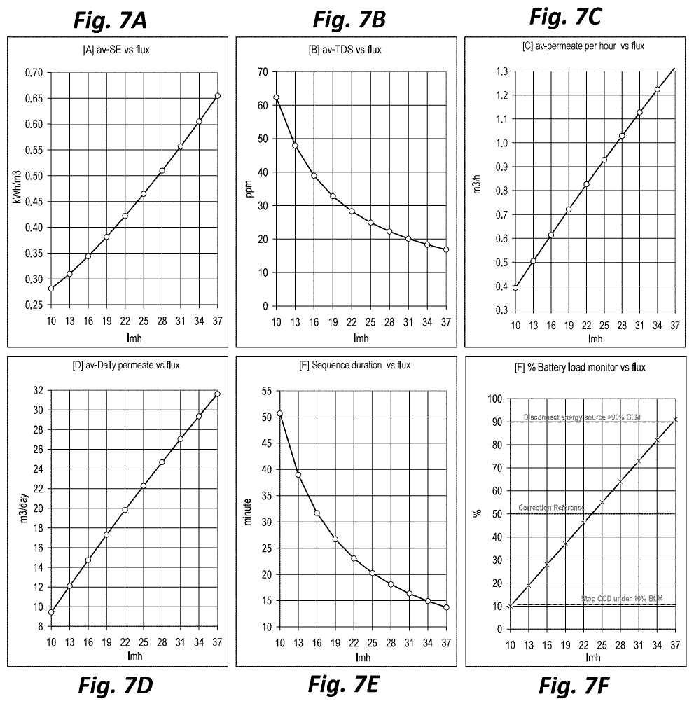

The performance simulation results as function of flux in the exemplified inventive system in FIG. 7(AF) show in [A], the average specific energy (av-SE); in [B], the average salinity (ppm, TDS) of permeates; in [C], the average hourly permeates production; in [D], the average daily permeates production; in [E], the average batch sequenced time duration; and in [F], the correlation between flux and BLM signals with a correction reference of 50% BLM, stop CCD operation reference under 10 lmh and a 10% BLM signal, and the disconnection reference of the battery from the natural energy source(s) above 37 lmh and a 90% BLM signal to prevent damage to the battery due to overcharge.

Under the annual solar and wind conditions in the location of the exemplified inventive system, the average annual projected daily permeates production is 23.5 m³/day (grater average expected during the summer and lower during the winter seasons) when operated only by solar panels according to the FIG. 1A design; or only by the wind turbines according to the FIG. 1B design; or by solar panels of half the area and a wind turbine with rotor of half the sweep area according to the FIG. 1C design. The stated production of the exemplified inventive system should meet the demand of a community of 235 residents at the consumption level of 100 liter/day/person and twice that number (470) at 50 liter/day/person. The components of the exemplified inventive system of the single-element CCD unit, solar panels, a small wind turbine (R=1.6 m; 0.55 kW DC generator and a 7-8 m long steel pipe support structure) and a battery are common, readily available and inexpensive, suggesting both high cost-effectiveness and affordability of said system, and alike of a greater production capacity, for extensive worldwide application in needy locations.

1. A system for RO desalination driven by a clean energy harvesting device from a variable power renewable natural energy source through an energy storage means, said system comprising:
an RO desalination proceeding in a batch closed circuit desalination (CCD) unit comprising one or more than one module in parallel, each of one or several membrane elements; a closed circuit concentrate recycling line with a circulation means from outlet(s) to inlet(s) of said module(s); a feed line with pressurizing means to inlet(s) of said module(s); a permeate release line off said module(s); and a line off said concentrate recycling line with actuated valve (AV) and check valve (CV) means to enable a brief periodic brine replacement by feed at low pressure after each batch desalination sequence under fixed flow and variable pressure conditions controlled by operational set-points of flux, module recovery and sequence recovery;
an energy harvesting device for conversion of variable power natural energy to DC (ampere-hour) as function power availability;
an energy storage means comprises a fixed voltage battery of a defined maximum (ampere-hour) capacity wherein said DC (ampere-hour) energy is collected as function power availability of said natural energy source and wherefrom energy is transmitted to said CCD unit through a DC/AC converter as function of its operation flux set-point, with said battery also equipped with a battery load monitor (BLM) which also shows of its remaining energy capacity as results of the input-output balance change; wherein
said system is made to operate continuously, pending a sufficient power availability from said natural energy source, by a programmable logic controller (plc) in said CCD unit with operational set-points of flux, module recovery and sequence recovery which also receives online data from said BLM and affects a periodic change of flux with a declined BLM capacity signal due to output>input responded by a declined flux is said CCD unit to enable output<input into said battery and with an increased BLM capacity signal due to output<input responded by an increased flux is said CCD unit to enable output>input into said battery and the intent of said periodic change of flux procedure is to restore BLM capacity at a desired predefined level (e.g., 50%) while said CCD unit operate, as well as to temporarily disconnect the line from said energy harvesting device to said batter when said CCD unit operates in its maximum defined flux range while the BLM capacity exceeds a maximum defined level (e.g., ≤90%) to avoid overcharge damage to said battery, or stop said CCD unit for lack of sufficient power when said CCD unit operates in its minimum defined flux range while the BLM capacity drops below a defined minimum value (e.g., 10%).

2. A system for CCD desalination by a variable power renewable natural energy source according to claim 1, wherein said pressurizing means (HP-vfd) is a high pressure pump with variable frequency drive means to enable controlled flow rates.

3. A system for CCD desalination by a variable power renewable natural energy source according to claim 1, wherein said circulation means (CP-vfd) is a flow circulation pump of a low pressure difference with variable frequency drive means to enable controlled flow rates.

4. A system for CCD desalination by a variable power renewable natural energy source according to claim 1, wherein said actuated valve means (AV) is a two-way valve of an closed/opened positions controlled by said plc with a closed position experienced during said batch desalination sequences and an opened position during said brief periodic brine replacement by feed at low pressure after each batch desalination sequence; and said check valve (CV) means dictate the flow direction in said concentrate recycling line during said brief periodic brine replacement by feed.

5. A system for CCD desalination by a variable power renewable natural energy source according to claim 1, wherein said energy harvesting device refers to solar panels for solar radiation conversion to DC (ampere-hour) energy as function solar energy availability.

6. A system for CCD desalination by a variable power renewable natural energy source according to claim 1, wherein said energy harvesting device is a wind turbine with a DC generator for wind power conversion to DC (ampere-hour) energy as function of wind power availability.

7. A system for CCD desalination by a variable power renewable natural energy source according to claim 1, wherein said energy harvesting device is solar panels and wind turbines with DC generators together for continuous generation of DC (ampere-hour) energy as from both said sources simultaneously.

8. A system for CCD desalination by a variable power renewable natural energy source according to claim 1, wherein said feed water to said system comprises either of seawater, brackish water, or contaminated ground and/or surface water, according to which the system is designed.
